(19) United States
(12) Patent Application Publication
(10) Pub. No.: US 2026/0293944 A1
(43) Pub. Date: Oct. 1, 2026

(54) INSTANT SNACK BAR MIXTURE

(71) Applicant: Abu Dhabi University, Abu Dhabi (AE)

(72) Inventors: Nauman Khalid, Abu Dhabi (AE); Aqsa Akhtar, Abu Dhabi (AE); Iram Aslam, Abu Dhabi (AE)

(73) Assignee: Abu Dhabi University, Abu Dhabi (AE)

(21) Appl. No.: 19/096,314

(22) Filed: Mar. 31, 2025

(51) Int. Cl. A23L 11/00; A23J 3/14; A23L 5/00; A23L 5/10

(52) U.S. Cl. CPC A23L 11/05; A23J 3/14; A23L 5/13; A23L 5/55

(57) ABSTRACT

A process for making a protein enriched instant snack bar mix includes dehydrating steam pulses. Dehydrating the steam pulses generates broken pulses. The process includes soaking the broken pulses in water. The process includes steaming the broken pulses in a steamer. The process includes drying the broken pulses. The process includes grinding the broken pulses. The process includes drying the pulses. The process includes mixing the broken pulses with dried dates, jaggery, milk powder and nuts to generate the protein enriched instant snack bar mix.

### BACKGROUND

Over time, people are more concerned to consume healthy and nutritious food rather the conventional foods. They look forward the food that is quick in preparation, nutritious and presents good taste. Snack bars are one of the ready to eat products that have been consumed by people as part of their regular meal, as a dessert (after lunch or dinner), and as meal replacers.

The desired quality attributes of protein snack bars are their crunchiness, crispiness, and taste, rich source of protein and fiber, and low in fat and calories. The process of preparing protein-based snack foods generally comprises the steps of preconditioning, mixing, molding, cooking, chilling, dehydrating, and storage. The preconditioning involves the destoning, cleaning, and soaking of the dried pulses in water for the hydrating purpose.

However, all these treatments increase the overall moisture level up to 50% in pulses. The protein bars which are made with a blend of pulses and legumes contained more than 10% moisture, cannot be stored for longer due to higher moisture content, and exhibited poor crunchiness with mold (fungus) growth. The excessive drying and heating cause the change in color as darker, loss of taste, and increase hardness in protein-based snack bars throughout 6 months of storage. This hardness and color change issue limits the use of whole proteins from plant sources in snack bars at the commercial level.

Although there have been attempts are to formulate protein-based snack bars with different sugars and cereal base floors, that are high in nutritional value and disease modulation aspects are missing in them, which now lowers popularity in terms of functional attributes. Accordingly, there is no current process for making protein snack bars that resolve the above issues.

### BRIEF DESCRIPTION OF DRAWINGS

FIG. 1 is a diagram of a database of materials;

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may allow for a process of making a protein enriched instant snack bar mix that includes: dehydrating steamed pulses at pasteurization temperature, which is reconstituted in the presence of water at 80° C., soaking the broken pulse in water with pulse to water ratio (3:1) for eight hours in 55° C. warm water, steaming the soaked pulses at a temperature of 75° C. for 30 minutes in a laboratory steamer, drying the steamed pulses in a hot air oven at 60° C. for 72 hours, grinding of the steamed-dried pulses in lab grinders to form coarse of approximately 1,000 microns in size, size reduction and drying of the dates at 72° C. in a dehydrator for 72 hours until moisture retained less than 5%, grinding of the nuts in laboratory grinders until the particle size<500 micron achieved, mixing the dried pulses, dried dates, jaggery, milk powder and nuts in a handheld laboratory mixer to form an instant protein enriched snack bar mix, reconstituting the 100 g (grams) of instant protein enriched snack bar mix in 100 mL of the potable water heated at 80° C., stirring the 100 g protein enriched snack bar mix and 100 mL water for five minutes to form a thick paste, packaging of 100 g of the protein enriched snack bar mix in aluminum-laminate packaging to extend shelf life up to six months. In embodiments, the addition of date powders and whey protein isolates significantly reduces the residual moisture issue in the reconstituted baked protein-enriched snack bars. In embodiments, the addition of nuts induces antioxidant activity due to the presence of copper and reduced oxidation activities in protein-enriched snack bars. In embodiments, this protein-enriched instant snack bar mix exhibits a shelf life of up to six months in aluminum packaging and 12 days after baking without compromising the quality and functional attributes.

Accordingly, the current process relates to a protein enriched instant snack bar mix which is a protein-based instant powdered mix. In embodiments, the describes protein-based snack bar mix helps to boost proteins, immunity, and body repairs due to a combination of protein matrices from different sources. In embodiments, the described protein enriched instant snack bar mix is prepared by combining pulses mainly; Bengal gram, black gram and dehulled red lentils, nuts, and milk powder in a dehydrated form that exhibits extended shelf life, easy transportation over long distances, and convenience in availability for every type of population. In embodiments, the quick (e.g., from 72 hours or up to 10 ten hours before or after 72 hours) dehydration process increases the storage stability and as well improved shelf life by up to 6 months in aluminum and laminate packaging. In embodiments, the powder premix can be easily reconstituted with water and baked at any time. While the moisture absorption issue is very common in commercial snack bars, in this improved process using ingredients in dry form, can be reconstituted easily on rehydrating, and can serve as ready-to-eat products.

In embodiments, the ingredients choice made for the development of this product is based on their high nutritional value, low prices, easy availability, and most significantly to increase the acceptability of pulses in combined form. In embodiments, the product is developed using broken pulses generated during the milling of pulses and dried date powder. Being rich in cheap sources of complex proteins both from animals and plants, the protein-based snack bar mix is a healthy substitute for the regular high caloric-energy cereal-based snack bars. In embodiments, the addition of whey protein isolates (15 g) followed by mixing made the product unique and protein rich which addresses many health issues associated with protein deficiency, such as protein-energy malnutrition. Furthermore, the addition of date powder and whey protein isolate also acts as a water binder and reduces the moisture issue. Accordingly, the describe the protein enriched instant snack bar mix can exhibit a shelf life of up to six months.

Accordingly, the described protein enriched instant snack bar mix is made of dehydrated pulses, dried date powder, milk powder, and nuts. In embodiments, this described instant snack bar mix is stabilized by adjusting the process control variables to exhibit better shelf stability. To date, there is no instant pulse-based snack bar mix available in the local market that can be easily reconstituted to develop protein-based snack bars.

In embodiments, the described powdered snack bar mix exhibited tremendous benefits over snack bars. For example, the moisture issue has been resolved by using steamed technology for cooking the pulses and combining the ingredients in dry form. The addition of nuts primarily almonds, cashew nuts and sesame seed provide a good source of antioxidants as there are rich in copper. In embodiments, the described instant snack bar mix is a powdered blend (instant mix) of ingredients that are packaged under controlled conditions. In embodiments, the described instant snack bar mix, after reconstitution in water at its optimum temperature of 80° C., can form a thick paste of coarse particles. In embodiments the thick paste of coarse particles can be molded and baked at 95° C. for seven minutes to make the crunchier snack bars.

In embodiments, the instant pulse mix is prepared by incorporating steaming and closed chamber drying technology using a hot air oven to dehydrate the ingredients. In embodiments, by using the best combination of the ingredients, from plant and animal sources and optimizing the process control variables, particularly temperature, moisture, and time, the end product can be retained over longer periods of up to 6 months. In embodiments, the final described product is packaged in stable aluminum laminate packaging that ensures high-end product quality with less than 6% moisture and microbiological safety.

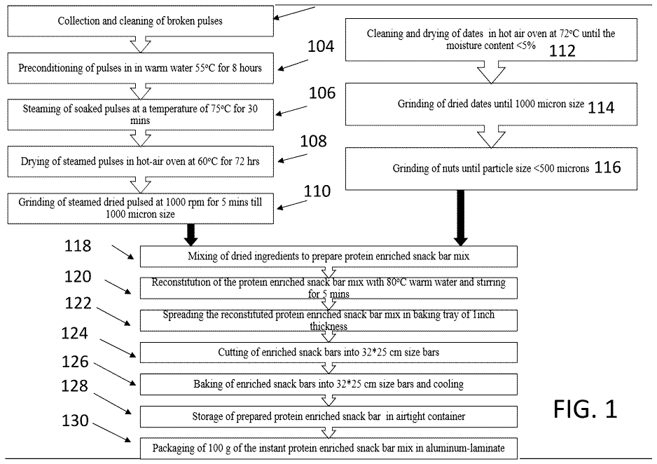

FIG. 1 describes an example process for making a protein enriched instant snack bar mix. At step 102, the broken pulses are collected and destoned. At step 104, the pulses are well soaked in warm water at 55° C. for eight hours in order to get fully hydrated and loosen the protein linkages and soften the pulse grains. As step 106, the soaked pulse grains are then steamed at a temperature of 75° C. for 30 minutes in a steamer. Accordingly, a well-hydrated pulses, this steaming temperature can efficiently cook the pulses. As step 108, the steamed pulses are dried in a hot-air oven at 60° C. for consecutive 72 hours (or up to four hours before or after 72 hours) until the moisture content is less than <5%. At step 110, after steaming, the pulse grains are grinded in a lab grinder at 1,000 rpm (revolutions per minute) for five minutes until the fine particles are obtained of less than 1,000 microns in size and stored in an airtight jar.

At step 112, the locally available dates are cleaned and dried in a hot air oven at 72° C. until a moisture content of less than 5% is achieved. At step 114, the dried dates are grinded in the lab using an electronic grinder until the 1,000-micron particle size is achieved. At step 116, the nuts used in the described premix are dehulled, cleaned and grinded in laboratory grinders to obtain particle size <500 microns. At step 118, the preparation of the protein enriched instant snack bar mix. In embodiments, all the steamed and dried pulse powder: Bengal gram, split black grams and unhulled red lentils in a ratio of 1:2:1 are mixed in specified proportions and a fine dry mixture is prepared in a hand-held laboratory mixture. After all the mentioned quantities of date powder, milk powder, and nuts are added and mixed well. In embodiments, the details of the ingredients include: bengal gram split at 100 g; split black gram at 200 g; unhulled red lentils at 100 g; whey protein isolates at 15 g; almonds at 30 g; walnuts at 20 g; pistachio at 20 g; cashio nuts at 25 g; sesame seeds at 10 g; dried dates powder at 20 g; juggery powder at 10 g; and milk powder at 10 g.

At step 120, reconstitution of the protein enriched snack bar mix. In embodiments, for the reconstitution of the instant pulse mix, firstly the 100 mL water is subjected to heating at 80° C. in the lab-used pan followed by the addition of the 100 g instant pulse mix and stirred properly for 5 mins until all the constituents are well rehydrated. At step 122, the prepared mixture is spread on the stainless-steel tray in a 1-inch thickness and, at step 124, cut into 32*25 cm size bars with a sharp knife. At step 126, after cutting the bars, the mixture is in the baking oven at 95° C. for seven minutes. At step 128, after baking these bars are cooled at room temperature and stored in air-tight jars and can be consumed for 12 days. At step 130, 100 g of the instant protein enriched snack bar mix is packed in aluminum laminate that has a shelf life of up to six months. In embodiments, the aluminum-laminates packaging acts as an efficient barrier to moisture and light.

For FIG. 1, the order of the blocks may be modified in other implementations. Further, non-dependent blocks may be performed in parallel.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various measurements are provided, such as weight/quantity amounts of materials used in a snack bar. For each of these measurement quantities, the quantities can range from the specified amount and still be considered to be compliant for the snack bar mix described above. This includes, Bengal gram split (100 grams), split black gram (200 grams), unhulled red lentils (100 grams), whey protein isolates (15 grams), almonds (30 grams), walnuts (20 grams), pistachio (20 grams), cashew nuts (25 grams), sesame seeds (10 grams), dried dates powder (20 grams), jaggery powder (10 grams), milk powder (10 grams).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A process for making a protein enriched instant snack bar mix, comprising:
dehydrating steam pulses, wherein the dehydrating the steam pulses generates broken pulses;
soaking the broken pulses in water;
steaming the broken pulses in a steamer;
drying the broken pulses;
grinding the broken pulses;
drying the pulses;
mixing the broken pulses with dried dates, jaggery, milk powder and nuts to generate the protein enriched instant snack bar mix.

2. The method of claim 1, wherein a ratio of the broken pulses to water is 3:1.

3. The method of claim 1, wherein the drying the broken pulses is done at 60° C.

4. The method of claim 1, wherein the dates are dried to 72° C. prior to the mixing with the broken pulses.

5. The method of claim 1, wherein the nuts are ground to less than 500 micron in size prior to the mixing with the broken pulses.

6. The method of claim 1, further comprising:
reconstituting 100 g of the instant protein enriched snack bar mix in 100 mL of additional water, wherein the water is at 80° C.; and
stirring the 100 g of the protein enriched snack bar mix and the additional water to form a thick paste.

7. The method of claim 6, wherein the thick paste is packaged into aluminum-laminate packaging.
